(19) United States
(12) Patent Application Publication
(10) Pub. No.: US 2011/0202640 A1
(43) Pub. Date: Aug. 18, 2011

(54) Identification of a destination server for virtual machine migration

(75) Inventor: Prasad VNH Pillutla, Andhra Pradesh (IN)

(73) Assignee: COMPUTER ASSOCIATES THINK, INC., Islandia, NY (US)

(21) Appl. No.: 12/658,701

(22) Filed: Feb. 12, 2010

(51) Int. Cl. G06F 15/177; G06F 9/455

(52) U.S. Cl. 709/221; 718/1

(57) ABSTRACT

A method for identification of a destination server for VM migration from a source server across a network is provided. The method comprises generating a profile for a virtual machine (VM) located on a source server, wherein the profile includes a plurality of parameters and a plurality of parameter constraints. The method further comprises polling a plurality of servers located on a network for values of the parameters and corresponding weights. It is determined whether the VM requires migration. Upon determination that migration is required, the method comprises identifying one or more destination servers located on the network that satisfy the parameter constraints, creating an ordered list of the one or more destination servers based on the corresponding weights if more than one destination server are identified, selecting a destination server from the ordered list, and migrating the VM to the selected destination server.

### TECHNICAL FIELD

The presently disclosed embodiments deal generally with the field of virtual machine systems, and more specifically with migration of virtual machines.

### BACKGROUND

A virtual machine (VM) is typically a logical entity, implemented over a hardware platform and operating system, where the VM can use multiple resources (such as memory, processors, network systems, etc.) to create virtual systems, each of which can run independently as a copy of an operating system. Virtualization technologies have become commonplace and now enable packaging of applications inside VMs, allowing multiple VMs to run on a single physical machine without interference. Such packaging increases resource utilization and consolidates server space and data center costs.

### SUMMARY OF EXAMPLE EMBODIMENTS

According to the aspects illustrated herein, the present disclosure describes a method for identification of a destination server for VM migration from a source server across a network. The method comprises generating a profile for a virtual machine (VM) located on a source server, wherein the profile includes a plurality of parameters and a plurality of parameter constraints. The method further comprises polling a plurality of servers located on a network for values of the parameters and corresponding weights. It is determined whether the VM requires migration. Upon determination that migration is required, the method comprises identifying one or more destination servers located on the network that satisfy the parameter constraints, creating an ordered list of the one or more destination servers based on the corresponding weights if more than one destination server are identified, selecting a destination server from the ordered list, and migrating the VM to the selected destination server.

Another embodiment of the present disclosure describes a system for identification of a destination server for VM migration from a source server across a network. The system employs one or more processors and a memory coupled to the one or more processors and configured to store a resource utilization module. The resource utilization module is executable by the one or more processors to implement steps comprising generating a profile for a virtual machine (VM) located on a source server, wherein the profile includes a plurality of parameters and a plurality of parameter constraints. The steps further comprise polling a plurality of servers located on a network for values of the parameters and corresponding weights. It is determined whether the VM requires migration. Upon determination that migration is required, the one or more destination servers located on the network that satisfy the parameter constraints are identified, an ordered list of the one or more destination servers is created based on the corresponding weights if more than one destination server are identified, a destination server is selected from the ordered list, and the VM is migrated to the selected destination server.

Another embodiment of the present disclosure describes a tangible computer readable medium encoded with logic, the logic being operable when executed on a processor to implement steps comprising generating a profile for a virtual machine (VM) located on a source server, wherein the profile includes a plurality of parameters and a plurality of parameter constraints. The steps further comprise polling a plurality of servers located on a network for values of the parameters and corresponding weights. It is determined whether the VM requires migration. Upon determination that migration is required, the one or more destination servers located on the network that satisfy the parameter constraints are identified, an ordered list of the one or more destination servers is created based on the corresponding weights if more than one destination server are identified, a destination server is selected from the ordered list, and the VM is migrated to the selected destination server.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

The figures described below set out and illustrate a number of exemplary embodiments of the disclosure. Throughout the figures, like reference numerals refer to identical or functionally similar elements. The figures are illustrative in nature and are not drawn to scale.

FIG. 1 illustrates an exemplary embodiment of a system for identification of a destination server for VM migration.

FIGS. 2A and 2B illustrate a flowchart of an exemplary method for identification of a destination server for VM migration.

### DETAILED DESCRIPTION

Virtualization solutions are increasingly used by organizations to improve resource utilization and consolidate server space and data center costs. Presently, multiple vendors offer virtualization solutions. Existing products offering virtualization solutions include “VMware ESX Server” by VMware, Inc., “Virtual Server” by Microsoft Corporation, “Xen” by XenSource, Inc., and the like. These solutions allow VM migration from one homogeneous environment to another, for example, from one ESX environment to another ESX environment or from one Hyper-V environment to another Hyper-V environment. A different manufacturer or vendor provides each of these environments. There exists no vendor-neutral solution for dynamic management and movement of VMs across non-homogeneous or heterogeneous virtual environments or different platforms, such as VM migration from Hyper-V environment to a VMware environment.

Current virtualization solutions restrict the user to a set of features provided by a particular vendor. For example, Hyper-V from Microsoft does not provide dynamic resource allocation but VMware does. Existing migration techniques do not allow VM migration across these two platforms, limiting flexibility in migration choices and consequently affecting system performance.

In contemporary systems, a user has no control over the selection of the server to which the VM will migrate as VM migration generally occurs automatically. In addition, the user cannot retrieve the information about the most suitable server matching the user's requirements.

Currently, only server-side parameters determine the requirement for VM migration. For example, a VM may migrate due to change in memory or number of CPU cycles requirement. Present migration techniques consider only a limited number of parameters, such as the number of CPU cycles and memory, often leading to an incorrect determination of VM migration requirements. Further, existing systems do not consider or allow addition of other parameters while determining whether a VM needs to be migrated or which server is best suited to host the VM. The VM migration technique disclosed herein may alleviate some of these problems and allow movement of VMs across different platforms or environments and between servers in a more efficient manner, employing more parameters and user input.

The following detailed description is made concerning the figures. Exemplary embodiments are described to illustrate the subject matter of the disclosure and do not limit its scope. Those of ordinary skill in the art will recognize a number of equivalent variations in the description that follows.

The present disclosure describes systems and methods for identification of a destination server for VM migration from a source server across a network, such that VM migration occurs based on calculations that are precise and complex. A novel algorithm (described in the embodiments of the present disclosure) determines, based on several user-defined parameters, the most appropriate destination server for a VM. The embodiments described here employ a database having profiles for VMs across the network. Each profile includes parameter values and weights corresponding to the parameters related to the source server. Further, the profile includes parameter constraints and weights corresponding to the parameters related to the VM hosted on the source server. The embodiments of the present disclosure also employ a resource utilization module that facilitates migration of the VM across the network. The VM migrates to a destination server satisfying the parameter constraints of the VM profile, if the VM needs to operate on a new server.

The embodiments allow VM migration across non-homogeneous virtual environments in addition to homogeneous migration of the VMs. Besides leveraging best features provided by different platforms, the embodiments of the present disclosure also provide user-initiated migration. Assignment of weights to the parameters resolves any conflict or collision between possible destination servers, improving efficiency of the ongoing VM migration.

It should be noted that the description below does not set out specific details of manufacture or design of the various components. Those of skill in the art are familiar with such details, and, unless departures from those techniques are set out, techniques and designs known in the art should be employed, and those in the art are capable of choosing suitable manufacturing and design details.

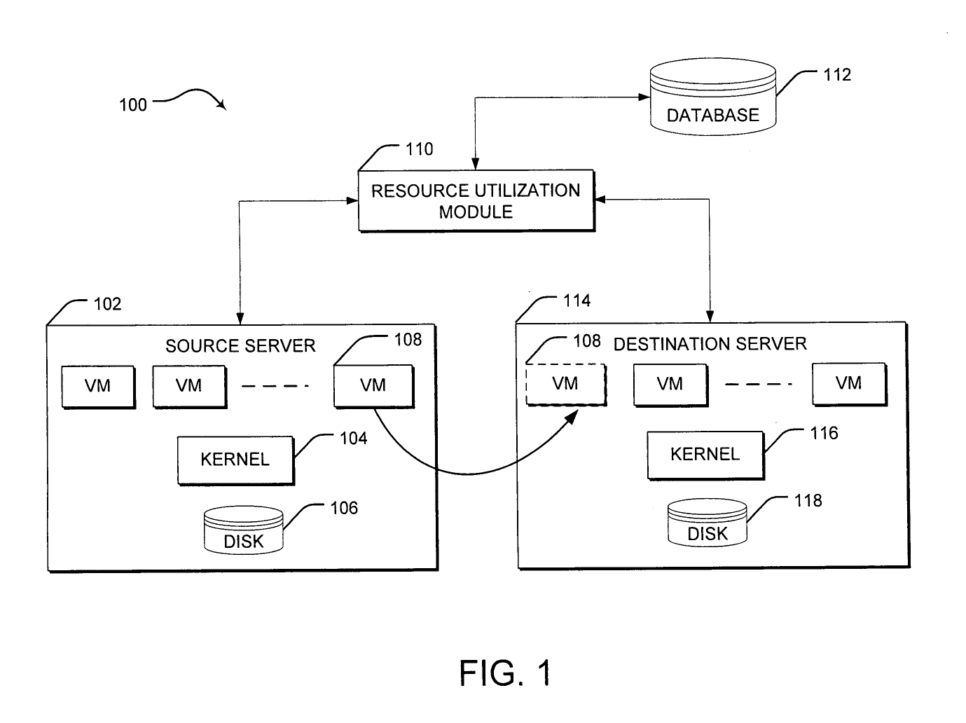

FIG. 1 illustrates an exemplary embodiment of a system 100 for identification of a destination server for VM migration across a network. The system 100 facilitates VM migration across homogeneous as well as non-homogeneous environments.

The system 100 operates across the network of multiple servers, each hosting one or more VMs. The network includes a source server 102 having a kernel 104 and a disk file repository 106. The source server 102 hosts several VMs including a VM 108. Further, the system 100 includes a resource utilization module 110, connected to a database 112.

Generally, a kernel controls process, memory, and device management. Process management involves the kernel executing multiple applications or processes simultaneously using one or more processors, while memory management includes providing full machine or server memory access to the kernel, allowing processes to access this memory safely, as and when required. For device management, the kernel controls peripherals through device drivers, regulating peripheral access. As device management is very specific to the Operating System (OS), each kernel design handles the device drivers differently.

Disk file repositories facilitate storage of disk files from various servers. Disk file systems are designed for the storage of files on a data storage device, most commonly a disk drive that might be directly or indirectly connected to the servers. Some disk file systems are journaling file systems, which log changes to a journal before committing them to a main file system. Additionally, versioning file systems allow a server file to exist in several versions at the same time.

The database 112 includes information about the VMs and the servers across the network. A server hosting a VM is referred to as a source server for the VM. A profile stores VM related information, for example, parameter values and weights corresponding to the parameters related to the source server. Further, the profile includes parameter constraints and weights corresponding to the parameters related to the VM hosted on the source server. In one implementation, the resource utilization module 110 may create a VM having a specific profile by writing the VM in a high-level language, such as C++ or Java. In addition, the database 112 stores information related to the servers across the network in the form of parameter values and weights corresponding to the parameters. According to particular embodiments, the parameter values for a server on the network may be variable. Exemplary parameters included in a profile with respect to the servers and the VMs may include, but are not limited to, those shown in the following Table:

TABLE 1

| Server Parameters | Virtual Machine Parameters |
|---|---|
| Available Memory | Available Virtual Memory |
| Available Processor | Available Virtual Processor |
| Page Faults | Virtual Page Faults |
| Cache Faults | Virtual Cache Faults |
| Host Configuration | Virtual Host Configuration |
| Network Activity | Virtual Network Activity |
| Disk Writes/Reads | Virtual Disk Writes/Reads |
| | Percentage of Host Processor being |
| | Used |
| | Percentage of Host Memory being |
| | Used |
| | Percentage of Host Network being |
| | Used |

The resource utilization module 110 facilitates VM migration across homogeneous as well as non-homogeneous virtual environments. The system 100 assesses a VM migration requirement and identifies a destination server based on detailed analysis of network data. The resource utilization module 110 determines the most appropriate destination server for a VM, based on several user-defined parameters. In one embodiment, the user may include additional parameters and corresponding constraints to refine the destination server search for VM migration. For example, the user may specify the constraint that the source server hosting the VM should not host another VM running Microsoft Exchange Server. If the source server violates this constraint, the resource utilization module 110 identifies possible destination servers that do not host a VM running Microsoft Exchange Server.

The resource utilization module 110 may poll the servers and the VMs on the network for parameter values. For example, values for available memory, page faults, or network activity may be gathered by polling. If the polled parameter values for a particular server violate the parameter constraints defined in the profile for the VM hosted on the server, the resource utilization module 110 may identify possible destination servers matching the VM profile. For example, if the parameter values of the source server 102 violate the parameter constraints specified in the VM 108 profile, the resource utilization module 110 may identify possible destination servers for the VM 108. The VM 108 migrates to the identified destination server that meets all the constraints specified in the VM 108 profile.

In case the resource utilization module 110 identifies more than one server satisfying the parameter constraints specified in the VM 108 profile (referred to as a collision), the resource utilization module 110 may retrieve the weights for each parameter of all the identified destination servers from the database 112. The resource utilization module 110 carries out calculations involving the retrieved weights and generates an ordered list to prioritize the identified destination servers. The best-suited server may appear at the top of the ordered list and the resource utilization module 110 may generally select it as the destination server for the VM 108. The selected destination server refers to the destination server 114. FIG. 1 exhibits that the selected server is the destination server 114, to which the VM 108 migrates (shown in dotted lines). The destination server 114 includes a kernel 116, a disk file repository 118, and the migrated VM 108. In an alternative embodiment, a user may initiate VM migration and select a destination server.

In another embodiment, the VM 108 migrates across homogeneous virtual environments. Disk files are copied from the source server 102 to the destination server 114 while migrating the VM 108. Alternatively, the VM 108 may migrate across non-homogeneous virtual environments. Here, the conversion of disk file format may be required to make the disk files of the source server compatible with the destination server. The resource utilization module 110 may convert the disk file formats from a format compatible with the source server to a format compatible with the selected destination server. For example, if a VM migrates from a Windows environment to a VMware environment, VHD disk format in Windows is converted to VMDK in VMware. Subsequently, the VM 108 migrates to the destination server 114.

In certain embodiments, a central repository stores the disk files from various servers on the network. In this case, VM migration does not require copying of disk files from one server to another, minimizing latency and further improving system performance. The resource utilization module 110 automatically selects the required disk files from the central repository.

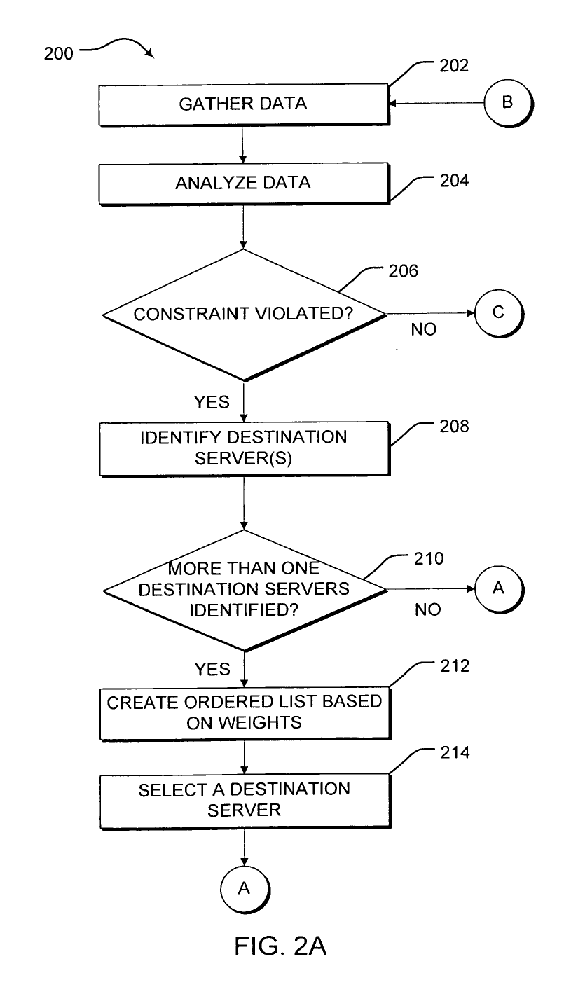

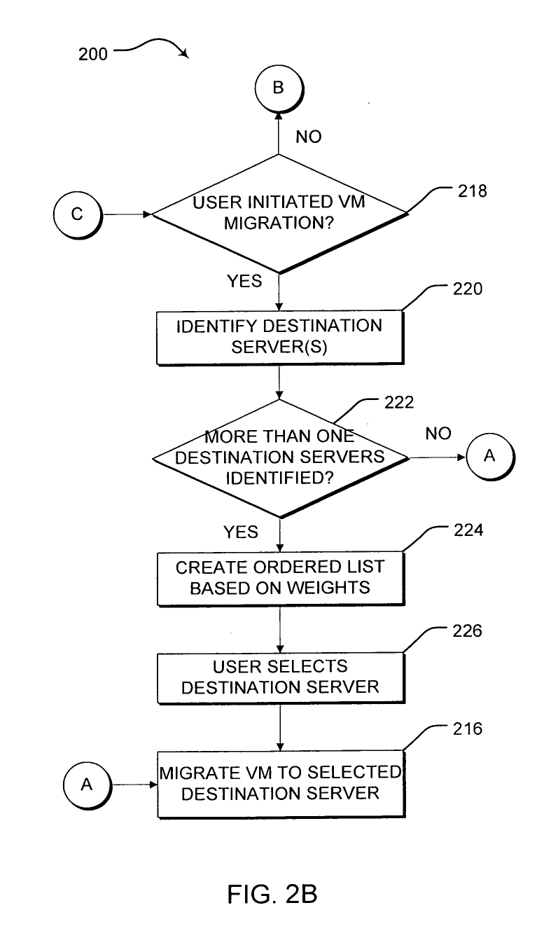

FIGS. 2A and 2B illustrate a flowchart of an exemplary method 200 for identification of a destination server for VM migration. FIGS. 2A and 2B describe the method 200 implemented by the system 100.

The source server 102 hosts the VM 108 having a defined profile. The profile stores parameter values and weights corresponding to the parameters related to the source server 102. Further, the profile includes parameter constraints and weights corresponding to the parameters related to the VM 108 hosted on the source server 102. Alternatively, a set of pre-defined VM profiles may be present across the network. A user may select any desired VM profile based on her preference. In either case, the user may include additional parameters and corresponding constraints to refine the destination server search for VM migration, as already described in relation with FIG. 1. In one implementation, the resource utilization module 110 may create a VM having a specific profile by writing the VM in a high-level language, such as C++ or Java.

At step 202, the resource utilization module 110 gathers data related to all the parameters. In one embodiment of the present method, a polling technique is employed for gathering the data. The method 200 gathers the values of the parameters related to the VMs and the servers across the network.

At step 204, the gathered data is analyzed. In one embodiment of the present method, all the servers and the VMs on the network are polled twice successively to ensure that the gathered values are just not random events or noise. Any discrepancy in a particular parameter value over two consecutive polls may indicate a possible error. A consistent value for a parameter over two poll intervals may affirm the validity of the retrieved value. For example, detection of 100 page faults over two successive poll intervals indicates validity of the retrieved page fault value. Alternatively, discovery of 100 page faults and 25 page faults over two successive poll intervals may indicate an isolated event of many page faults.

At step 206, the method 200 determines whether any parameter constraint related to the VM 108 on the source server 102 is violated. If such a violation is detected, the method 200 proceeds to identify possible destination servers for the VM 108. At step 208, the resource utilization module 110 identifies a destination server matching the profile of the VM 108.

At step 210, the method 200 checks whether more than one destination server is identified. If only one destination server is identified, the VM 108 migrates to the identified destination server as shown at step 216.

If more than one destination server are identified, an ordered list of the identified destination servers is created at step 212. The resource utilization module 110 gathers the assigned weights for each parameter of the identified destination servers from the database 112. In one embodiment, the resource utilization module 110 calculates the net sum of the products of the parameter values and weights corresponding to the parameters for each identified destination server. Based on these calculations, the resource utilization module 110 generates an ordered list to prioritize the identified destination servers. The best-suited server appears at the top of the ordered list and the resource utilization module 110 generally selects it as the destination server for the VM 108.

At step 214, the resource utilization module 110 automatically selects the first entry in the ordered list as the destination server. Referring to FIG. 1, the destination server 114 is determined to be the best-suited destination server for VM 108, which is migrated to the destination server 114 at step 216. During the VM 108 migration, all disk files are copied from the source server 102 to the destination server 114. In one implementation, the resource utilization module 110 automatically selects the required server-related disk files from a central repository during the VM 108 migration.

Returning to step 206, even when no constraint violation is detected, migration of the VM 108 can be made possible through user intervention. At step 218, the method 200 verifies user-initiated VM migration requirements. In one implementation, the user selects a specific VM, for example, the VM 108 hosted on the source server 102 and determines whether the VM 108 requires migration. In one embodiment, the user performs a right click operation and selects a migration option.

At step 220, the resource utilization module 110 identifies possible destination servers matching the VM 108 profile. At step 222, the method 200 checks whether more than one destination server is identified. If only one destination server is identified, the VM 108 is migrated to the identified destination server at step 216.

If more than one destination server are identified, the user assigns weights to the parameters based on business knowledge and importance of the servers and the VMs on the network. Based on the assigned weights, an ordered list of the identified destination servers is created at step 224.

At step 226, the user selects an identified destination server from the ordered list for the VM 108 migration. According to FIG. 1, the selected server is the destination server 114. At step 216, the VM 108 migrates to the selected destination server 114. During the VM 108 migration, all disk files are copied from the source server 102 to the destination server 114. In one embodiment, the required server-related disk files are automatically selected from a central repository during the VM 108 migration.

A source server in a network may host multiple VMs. Referring to FIG. 1, the source server 102 hosts several VMs including the VM 108. Assuming that the source server 102 violates the parameter constraints, the resource utilization module 110 proceeds to identify a destination server matching the VM 108 profile. According to particular embodiments, the resource utilization module 110 identifies three suitable destination servers and determines the best-suited destination server for the VM 108 migration. Tables 2, 3, and 4 show exemplary calculations made for creating an ordered list of possible destination servers.

TABLE 2

| Server - 1 | Parameters | | Value | Weight | Value * Weight |
|---|---|---|---|---|---|
| Available Memory | 2 | GB | 2 | 0.9 | 1.8 |
| Available Processor | 75% | | 75 | 1.0 | 75.0 |
| Page Faults | 120 | | 120 | 1.0 | 120.0 |
| Cache Faults | 150 | | 150 | 1.0 | 150.0 |
| Available Disk | 75% | | 75 | 1.0 | 75.0 |
| Cores | 4 | | 4 | 1.0 | 4.0 |
| Network Activity | 1 | Mbps | 1 | 1.0 | 1.0 |
| Disk Writes\Reads | 120 | per Sec | 120 | 1.0 | 120.0 |

| | |
|---|---|
| Sum | 546.8 |

TABLE 3

| Server - 2 | Parameters | | Value | Weight | Value * Weight |
|---|---|---|---|---|---|
| Available Memory | 2 | GB | 2 | 1.0 | 2.0 |
| Available Processor | 75% | | 75 | 0.9 | 67.5 |
| Page Faults | 120 | | 120 | 0.8 | 96.0 |
| Cache Faults | 150 | | 150 | 1.0 | 150.0 |
| Available Disk | 75% | | 75 | 1.0 | 75.0 |
| Cores | 4 | | 4 | 1.0 | 4.0 |
| Network Activity | 1 | Mbps | 1 | 1.0 | 1.0 |
| Disk Writes\Reads | 120 | per Sec | 120 | 1.0 | 120.0 |

| | |
|---|---|
| Sum | 515.5 |

TABLE 4

| Server - 3 | Parameters | | Value | Weight | Value * Weight |
|---|---|---|---|---|---|
| Available Memory | 2 | GB | 2 | 0.9 | 1.8 |
| Available Processor | 75% | | 75 | 0.9 | 67.5 |
| Page Faults | 120 | | 120 | 0.8 | 96.0 |
| Cache Faults | 150 | | 150 | 1.0 | 150.0 |
| Available Disk | 75% | | 75 | 1.0 | 75.0 |
| Cores | 4 | | 4 | 1.0 | 4.0 |
| Network Activity | 1 | Mbps | 1 | 1.0 | 1.0 |
| Disk Writes\Reads | 120 | per Sec | 120 | 1.0 | 120.0 |

| | |
|---|---|
| Sum | 515.3 |

In the example above, server 1, server 2, and server 3 have equal parameter values. In this scenario, weights play a role in identifying the best-suited destination server for the VM 108 migration. In the Tables 2, 3 and 4, parameter values are listed for the three identified destination servers. Weights ranging from 0 to 1 are assigned to the parameters to determine the priority order of the parameters of a server. Available memory is assigned a weight 0.9 (in Tables 2 and 4), indicating that only 90% of the parameter value may be considered during VM migration.

The resource utilization module 110 gathers weights for each parameter related to the three identified destination servers from the database 112 and calculates the sum of the products of the parameter values and weights corresponding to the parameters of each identified destination server. Based on these calculations, the resource utilization module 110 generates an ordered list to prioritize the three identified destination servers. In the present example, the identified destination server with the highest sum appears as the first entry in the ordered list. The destination server appearing at the top of the ordered list is considered the best-suited destination server and the resource utilization module 110 generally selects it as the destination server for the VM 108 migration.

In the present example, the ordered list places server 1 at the top of the ordered list, then server 2, and finally server 3. During automatic migration, the resource utilization module 110 selects the server 1 as the destination server for the VM 108 migration. Further, the resource utilization module 110, in coordination with a backend service, monitors and updates weights on timely basis.

VM parameters are also considered for determining VM migration requirement and during the identification of a destination server. For example, in the illustrated embodiment, there exist three VMs on server 1—VM1, VM2, and VM3. There exists one more server—Server 2, which hosts VM4. The user can create a VM profile indicating that no VMs hosted on Server 2 should be migrated to a server having one or more VMs running with 90% CPU or to a server having more than 120 page faults. Such parameters and constraints allow adaptation of the VM migration process to meet specific user and system requirements.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data.

Although the present invention has been described in detail, it should be understood that various changes, substitutions, and alterations can be made without departing from the spirit and scope of the invention as defined by the appended claims. It will be appreciated that several of the above-disclosed and other features and functions, or alternatives thereof, may be desirably combined into many other different systems or applications. Those skilled in the art may subsequently make various presently unforeseen or unanticipated alternatives, modifications, variations, or improvements therein, which the following claims also encompass.

What is claimed is:

1. A method, comprising:
generating a profile for a virtual machine (VM) located on a source server, wherein the profile includes a plurality of parameters and a plurality of parameter constraints;
polling a plurality of servers located on a network for values of the parameters and corresponding weights;
determining whether the VM requires migration; and
upon determination that VM migration is required:
identifying one or more destination servers located on the network that satisfy the parameter constraints;
creating an ordered list of the one or more destination servers based on the corresponding weights if more than one destination server are identified;
selecting a destination server from the ordered list; and
migrating the VM to the selected destination server.

2. The method of claim 1, wherein determining whether the VM requires migration comprises detecting violation of the parameter constraints by the source server.

3. The method of claim 1, wherein determining whether the VM requires migration comprises accepting a user request for VM migration.

4. The method of claim 1, wherein the VM is migrated automatically based on constraint violation detection.

5. The method of claim 1, wherein the VM is migrated manually by a user.

6. The method of claim 1, further comprising:
defining a profile for the VM using parameters having constraints as selected by a user; and
assigning weights as selected by the user.

7. The method of claim 1, wherein the source server and the selected destination server are homogeneous.

8. The method of claim 1, wherein the source server and the selected destination server are non-homogeneous.

9. The method of claim 8 further comprising converting disk file formats from a format compatible with the source server to a format compatible with the selected destination server.

10. The method of claim 1 further comprising copying files from the source server to the selected destination server.

11. The method of claim 1 further comprising storing disk files in a central repository.

12. A system, comprising:
one or more processors;
memory coupled to the one or more processors and configured to store a resource utilization module, the resource utilization module being executable by the one or more processors to implement steps comprising:
generating a profile for a virtual machine (VM) located on a source server, wherein the profile includes a plurality of parameters and a plurality of parameter constraints;
polling a plurality of servers located on a network for values of the parameters and corresponding weights;
determining whether the VM requires migration; and
upon determination that VM migration is required:
identifying one or more destination servers located on the network that satisfy the parameter constraints;
creating an ordered list of the one or more destination servers based on the corresponding weights if more than one destination server are identified;
selecting a destination server from the ordered list; and
migrating the VM to the selected destination server.

13. The system of claim 12, wherein determining whether the VM requires migration comprises detecting violation of the parameter constraints by the source server.

14. The system of claim 12, wherein the VM is migrated automatically based on constraint violation detection.

15. The system of claim 12, wherein the source server and the selected destination server are non-homogeneous.

16. The system of claim 15, wherein the resource utilization module is further configured to convert disk file formats from a format compatible with the source server to a format compatible with the selected destination server.

17. The system of claim 12, wherein the resource utilization module is further configured to copy files from the source server to the selected destination server.

18. The system of claim 12 further comprising a central repository for storing the disk files.

19. A tangible computer readable medium encoded with logic, the logic being operable when executed on a processor to implement steps comprising:
generating a profile for a virtual machine (VM) located on a source server, wherein the profile includes a plurality of parameters and a plurality of parameter constraints;
polling a plurality of servers located on a network for values of the parameters and corresponding weights;
determining whether the VM requires migration; and
upon determination that VM migration is required:
identifying one or more destination servers located on the network that satisfy the parameter constraints;
creating an ordered list of the one or more destination servers based on the corresponding weights if more than one destination server are identified;
selecting a destination server from the ordered list; and
migrating the VM to the selected destination server.

20. The logic of claim 19, wherein determining whether the VM requires migration comprises detecting violation of the parameter constraints by the source server.
